(19) United States
(12) Patent Application Publication
(10) Pub. No.: US 2015/0342000 A1
(43) Pub. Date: Nov. 26, 2015

(54) LED BACKLIGHT DRIVE CIRCUIT AND LIQUID CRYSTAL DISPLAY

(71) Applicant: SHENZHEN CHINA STAR OPTOELECTRONICS TECHNOLOGY CO., LTD., Shenzhen, Guangdong (CN)

(72) Inventor: Hua ZHANG, Shenzhen, Guangdong (CN)

(73) Assignee: SHENZHEN CHINA STAR OPTOELECTRONICS TECHNOLOGY CO., LTD., Shenzhen, Guangdong (CN)

(21) Appl. No.: 14/761,943

(22) PCT Filed: Feb. 20, 2015
(86) PCT No.: PCT/CN2013/071685

§ 371 Date: Jul. 18, 2015

(30) Foreign Application Priority Data
Jan. 29, 2013 (CN) 2013 10033417.3

(51) Int. Cl. H05B 33/08

(52) U.S. Cl. CPC H05B 33/0845

(57) ABSTRACT

An LED backlight drive circuit includes a drive chip and a frequency setting circuit. The frequency setting circuit includes at least two groups of resistors that are connected in parallel and having an end connected to a frequency setting pin RT of the drive chip and an opposite end grounded. Adjustment of a frequency of a MOSFET drive signal is achieved by changing the resistance of at least one of resistors. The LED backlight drive circuit and the liquid crystal display include multiples resistors connected in a proper arrangement of parallel and serial connection so as to provide an increased number of more precise values of resistance through various combinations of the resistances of the resistors, making it convenient to adjust a frequency of an MOSFET drive signal.

### CROSS REFERENCE TO RELATED APPLICATIONS

This application claims the priority of Chinese Patent Application No. 201310033417.3, entitled “LED Backlight Drive Circuit and Liquid Crystal Display”, filed on Jan. 29, 2013, the disclosure of which is incorporated herein by reference in its entirety.

### BACKGROUND OF THE INVENTION

1. Field of the Invention

The present invention relates to the field of image displaying, and in particular to an LED (Light-Emitting Diode) backlight drive circuit and a liquid crystal display.

2. The Related Arts

In an LED backlight drive circuit, a drive signal is supplied to a MOSFET (Metal-Oxide-Semiconductor Field Effect Transistor) from a constant-current drive chip and a frequency of the drive signal is determined by the resistance of a resistor externally connected to a frequency setting pin RT of the chip according to the following formula: f(kHz)=constant/R. In other words, the frequency f is the ratio of a constant (this being determined according to the manufacturers and different from manufacture to manufacturer) to the resistance R.

In the LED backlight drive circuit, the frequency of the MOSFET drive signal is often set in the range of 100-200 KHz. For a frequency that is excessively small, the conduction loss of the MOSFET is great; for a frequency that is excessively large, the switching loss of the MOSFET is great. Both cause a high temperature of the MOSFET and the conversion efficiency of the entire circuit is lowered down. As shown in FIG. 1, in a known LED backlight drive circuit, the frequency setting pin RT is provided with only one frequency setting resistor R. Such a backlight drive circuit suffers certain technical drawbacks, including:

(1) A single frequency setting resistor R usually has a resistance that is one of several commonly used values and there might not be a resistor having a desired resistance to adjust the drive frequency of the MOSFET, making the adjustment operation difficult.

(2) To test the electrical characteristics of a circuit board, it often needs to inspect the safety property of the entire circuit for the open-circuiting and shorting states of each of the components; and in the condition that the frequency setting resistor R is made shorted, according to the formula f(KHz)=constant/R, the frequency of the of the MOSFET drive signal becomes infinite, leading to an extremely large switching loss of the MOSFET and an abrupt increase of temperature, and eventually causing a potential risk of explosion of the MOSFET.

### SUMMARY OF THE INVENTION

The present invention is made to overcome a technical problem for providing a light-emitting diode (LED) backlight drive circuit that allows for precise adjustment of a frequency of a drive signal and reduces potential risk of open-circuiting/shorting of a resistor and a liquid crystal display.

To overcome the above technical problem, the present invention provides an LED backlight drive circuit, which comprises a drive chip and a frequency setting circuit. The frequency setting circuit comprises at least two groups of resistors that are connected in parallel and has an end connected to a frequency setting pin RT of the drive chip and an opposite end grounded, wherein adjustment of a frequency of a MOSFET drive signal is achieved by changing the resistance of at least one of resistors.

In the above LED backlight drive circuit, each of the groups comprises at least two resistors connected in series.

In the above LED backlight drive circuit, the frequency setting circuit comprises two groups of resistors connected in parallel, in which a first group comprises R1 and R2, R1 and R2 being connected in series, and a second group comprises R3 and R4, R3 and R4 being connected in series.

The present invention also provides an LED backlight drive circuit, which comprises: a drive chip and a frequency setting circuit. The frequency setting circuit comprises two groups of resistors that are connected in parallel and has an end connected to a frequency setting pin RT of the drive chip and an opposite end grounded, wherein adjustment of a frequency of a MOSFET drive signal is achieved by changing the resistance of at least one of resistors, and wherein the first group comprises R1 and R2, R1 and R2 being connected in series, and a second group comprises R3 and R4, R3 and R4 being connected in series.

The present invention further provides a liquid crystal display, which comprises at least an LED backlight drive circuit. The LED backlight drive circuit comprises a drive chip and a frequency setting circuit. The frequency setting circuit comprises at least two groups of resistors that are connected in parallel and has an end connected to a frequency setting pin RT of the drive chip and an opposite end grounded, wherein adjustment of a frequency of a MOSFET drive signal is achieved by changing the resistance of at least one of resistors.

In the above liquid crystal display, each of the groups comprises at least two resistors connected in series.

In the above liquid crystal display, the frequency setting circuit comprises two groups of resistors connected in parallel, in which a first group comprises R1 and R2, R1 and R2 being connected in series, and a second group comprises R3 and R4, R3 and R4 being connected in series.

The present invention provides an LED backlight drive circuit and a liquid crystal display, in which multiples resistors connected in a proper arrangement of parallel and serial connection so as to provide an increased number of more precise values of resistance, making it convenient to adjust a frequency of an MOSFET drive signal. When one of the resistor is open-circuited or shorted, the presence of the remaining resistors ensures no event of infinitesimal or infinite value for the frequency of the MOSFET drive signal, thereby reducing the potential risk caused by open-circuiting or shorting of the circuit and improving operation safety.

### BRIEF DESCRIPTION OF THE DRAWINGS

To more clearly illustrate the technical solutions proposed in an embodiment of the present invention or the prior art, a brief description of the drawings that are necessary for describing the embodiment of the present invention or the prior art is given below. It is obvious that the drawings that will be described below show only some embodiments of the present invention and for those having ordinary skills of the art, other drawings may also be readily available from the attached drawings without the expense of creative effort and endeavor.

FIG. 1 is a schematic view illustrating a conventional light-emitting diode (LED) backlight drive circuit; and

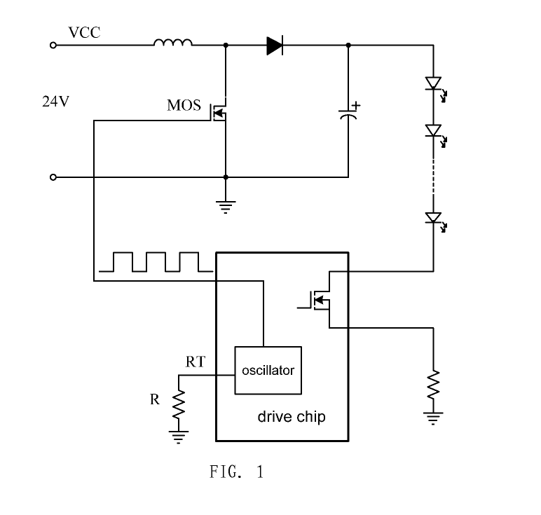

FIG. 2 is a schematic view illustrating an LED backlight drive circuit according to an embodiment of the present invention.

### DETAILED DESCRIPTION OF THE PREFERRED EMBODIMENTS

A description will be given to a preferred embodiment of the present invention with reference to the attached drawings.

An embodiment of the present invention provides a light-emitting diode (LED) backlight drive circuit, which comprises: a drive chip and a frequency setting circuit. The frequency setting circuit comprises at least two groups of resistors that are connected in parallel and has an end connected to a frequency setting pin RT of the drive chip and an opposite end grounded. A frequency of a drive signal of a metal-oxide-semiconductor field-effect transistor (MOSFET) can be adjusted by changing the resistance of at least one of the resistors.

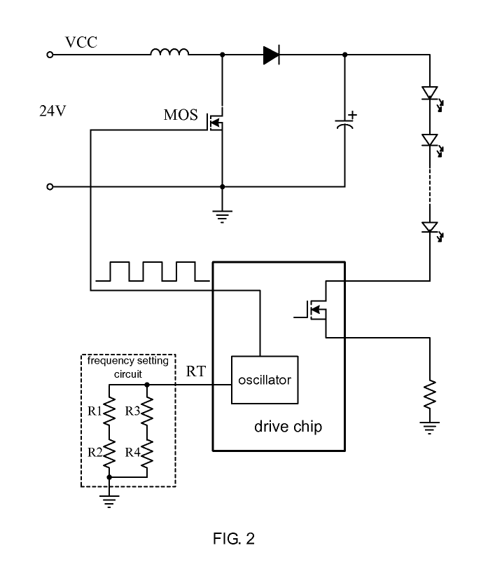

Specifically, reference being had to FIG. 2, the frequency setting circuit comprises two groups of resistors that are connected in parallel, in which the first resistor group comprises R1 and R2 and R1 and R2 are connected in series; and the second resistor group comprises R3 and R4 and R3 and R4 are connected in series. With such a circuit arrangement, the frequency setting circuit has an equivalent resistance R, of which a reciprocal satisfies 1/R=1/(R1+R2)+1/(R3+R4). As mentioned previously, according to formula: f(KHz)=constant/R, changing the value of R changes the frequency of the MOSFET drive signal and thus, combinations of the four resistances R1 to R4 of the frequency setting circuit would gives an increased number of more precise candidate resistances for more precisely adjusting the frequency of the MOSFET drive signal. When one of R1 to R4 is shorted or open-circuited, the presence of the remaining three resistors still sufficient to ensure there is no event of infinitesimal or infinite value for the frequency of the MOSFET drive signal thereby reducing the potential risk of open-circuiting or shorting the resistors and improving operation safety.

An example will be given for illustration. Assuming the value of the constant of the drive chip shown in FIG. 2 is 1000 and the frequency of the MOSFET drive signal is to be set to 120 KHz, the equivalent resistance R of the frequency setting circuit must be 25/3 kΩ. If, among the resistors that are commonly used, there is no one that provides such a precise value of resistance of 25/3 kΩ, then as explained in the section of “BACKGROUND OF THE INVENTION”, it is generally hard to make an adjustment that completely satisfies the need for the frequency of the MOSFET drive signal. However, if the frequency setting circuit of FIG. 2 is adopted, then by selecting R1 as 10 kΩ, R2 15 kΩ, R 10 kΩ, and R4 2.5 kΩ, all being commonly used resistances, 1/R=1/(10+15)+1/(10+2.5)=1/25+1/12.5=1/25+2125=3/25 kΩ. This means R=25/3 kΩ. In other words, through such an arrangement of combination, commonly used resistors may be properly selected to satisfy the need for any specific or unique value of resistance. When it needs to re-adjust the frequency of the MOSFET drive signal, this can be done by simply changing the resistance of at least one of the resistor (by selecting one or more resistors having different resistances) so that the constraint that has been imposed to the prior art that uses only a single resistor in selecting resistance can be overcome, making it convenient and easy to adjust the frequency of the MOSFET drive signal.

On the other hand, in the frequency setting circuit of FIG. 2, each resistor group comprises at least two resistors. If one (such as R1) of them is shorted, then there is at least the other one resistor (R2) present so that the frequency of the MOSFET drive signal would not become infinite and no abrupt increase of temperature may occur to lead to a potential risk of explosion of the MOSFET.

It is manifest that provided the entirety of the LED backlight drive circuit is made excessively complicated, the frequency setting circuit may comprises more parallel-connected groups of resistors and each of the groups comprises more than two serially-connected resistors so that an even increased number of even more precise values of resistance can be provided for more flexibly adjusting the frequency of the MOSFET drive signal. The principle is similar to the illustration of FIG. 2 and no repeated description will be given herein.

A second embodiment of the present invention provides a liquid crystal display that comprises at least the LED backlight drive circuit of FIG. 2. The LED backlight drive circuit comprises a drive chip and a frequency setting circuit. The frequency setting circuit comprises at least two groups of resistors that are connected in parallel and has an end connected to a frequency setting pin RT of the drive chip and an opposite end grounded. The frequency of the MOSFET drive signal can be adjusted by changing the resistance of at least one of the resistors.

In the instant embodiment, the frequency setting circuit is identical to that of the previous embodiment. For example, each of the resistor group comprises at least two resistors that are connected in series. Specifics are also illustrated in FIG. 2, where the frequency setting circuit comprises two resistor groups that are connected in parallel in which the first resistor group comprises R1 and R2 and R1 and R2 are connected in series; and the second resistor group comprises R3 and R4 and R3 and R4 are connected in series.

The present invention provides an LED backlight drive circuit and a liquid crystal display, in which multiples resistors connected in a proper arrangement of parallel and serial connection so as to provide an increased number of more precise values of resistance, making it convenient to adjust a frequency of an MOSFET drive signal. When one of the resistor is open-circuited or shorted, the presence of the remaining resistors ensures no event of infinitesimal or infinite value for the frequency of the MOSFET drive signal, thereby reducing the potential risk caused by open-circuiting or shorting of the circuit and improving operation safety.

Disclosed above are only the preferred embodiments of the present invention, which are not intended to constrain the scope of the present invention that is defined in the appended claims. Equivalent modifications made according to the claims are considered within the protection scope of the present invention.

What is claimed is:

1. A light-emitting diode (LED) backlight drive circuit, comprising: a drive chip and a frequency setting circuit, the frequency setting circuit comprising at least two groups of resistors that are connected in parallel and having an end connected to a frequency setting pin RT of the drive chip and an opposite end grounded, wherein adjustment of a frequency of a metal-oxide-semiconductor field-effect transistor (MOSFET) drive signal is achieved by changing the resistance of at least one of resistors.

2. The LED backlight drive circuit as claimed in claim 1, wherein each of the groups comprises at least two resistors connected in series.

3. The LED backlight drive circuit as claimed in claim 2, wherein the frequency setting circuit comprises two groups of resistors connected in parallel, in which a first group comprises R1 and R2, R1 and R2 being connected in series, and a second group comprises R3 and R4, R3 and R4 being connected in series.

4. A light-emitting diode (LED) backlight drive circuit, comprising: a drive chip and a frequency setting circuit, the frequency setting circuit comprising two groups of resistors that are connected in parallel and having an end connected to a frequency setting pin RT of the drive chip and an opposite end grounded, wherein adjustment of a frequency of a metal-oxide-semiconductor field-effect transistor (MOSFET) drive signal is achieved by changing the resistance of at least one of resistors, and wherein the first group comprises R1 and R2, R1 and R2 being connected in series, and a second group comprises R3 and R4, R3 and R4 being connected in series.

5. A liquid crystal display, comprising at least a light-emitting diode (LED) backlight drive circuit, the LED backlight drive circuit comprising a drive chip and a frequency setting circuit, the frequency setting circuit comprising at least two groups of resistors that are connected in parallel and having an end connected to a frequency setting pin RT of the drive chip and an opposite end grounded, wherein adjustment of a frequency of a metal-oxide-semiconductor field-effect transistor (MOSFET) drive signal is achieved by changing the resistance of at least one of resistors.

6. The liquid crystal display as claimed in claim 5, wherein each of the groups comprises at least two resistors connected in series.

7. The liquid crystal display as claimed in claim 6, wherein the frequency setting circuit comprises two groups of resistors connected in parallel, in which a first group comprises R1 and R2, R1 and R2 being connected in series, and a second group comprises R3 and R4, R3 and R4 being connected in series.
